(19) United States
(12) Patent Application Publication
(10) Pub. No.: US 2013/0031360 A1
(43) Pub. Date: Jan. 31, 2013

(54) PROCESS CONTROL SYSTEM

(71) Applicants: Gerd DEWITZ, Bad Salzuflen (DE); Gunnar Prytz, Spikkestad (NO); Michael Gienke, Hannover (DE); Ragnar Schierholz, Würenlos (CH); Stefan Bollmeyer, Minden (DE); Thomas Pauly, Västeras (SE)

(72) Inventors: Gerd DEWITZ, Bad Salzuflen (DE); Gunnar Prytz, Spikkestad (NO); Michael Gienke, Hannover (DE); Ragnar Schierholz, Würenlos (CH); Stefan Bollmeyer, Minden (DE); Thomas Pauly, Västeras (SE)

(73) Assignee: ABB Technology AG, Zurich (CH)

(21) Appl. No.: 13/553,287

(22) Filed: Jul. 19, 2012

(30) Foreign Application Priority Data
Jul. 19, 2011 (DE) 10 2011 108 003.5

(51) Int. Cl. H04L 29/06

(52) U.S. Cl. 713/156

(57) ABSTRACT

A process control system is disclosed which can include a plurality of spatially distributed, internetworked network subscribers with secure communication between the network subscribers via a communication network. Communication integrity can be based on an interchange of certificates. In order to protect the communication integrity, the process control system can include a central certification point which is an integral part of the process control system and allocates and distributes certificates.

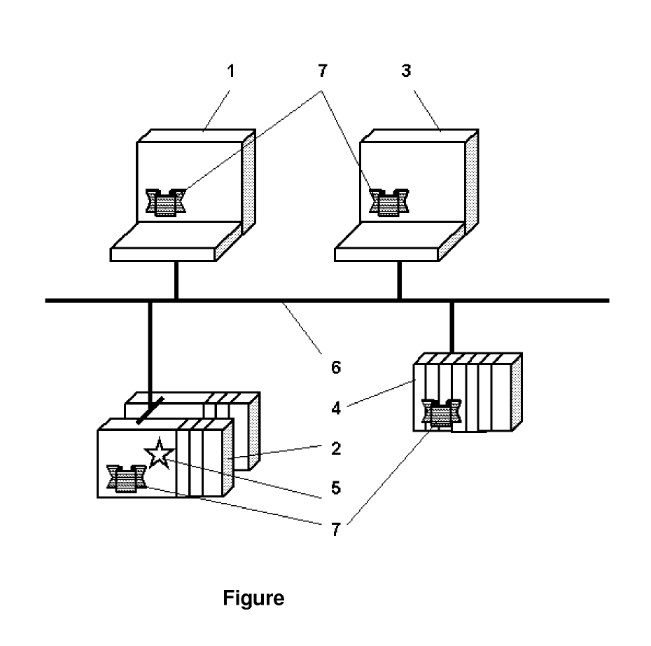

### RELATED APPLICATION

This application claims priority under 35 U.S.C. §119 to German Patent Application No. 10 2011 108 003.5 filed in Germany on Jul. 19, 2012, the entire content of which is hereby incorporated by reference in its entirety.

### FIELD

This disclosure relates to a process control system, such as a system for a plurality of spatially distributed, internetworked subscribers with secure communication between the subscribers.

### BACKGROUND

Process control systems are known and are, for example, described in terms of their structure and function in EP 0 597 561. A plant operator can impose very high demands on the availability, integrity and reaction times of such a process control system. According to known systems, internetworked subscribers are connected to one another via manufacturer-specific bus systems or serial connections which are a technical barrier to access from standard IT components such as notebooks and PCs. This can result in a considerably reduced target both for deliberately caused manipulations and for impairments of the operational readiness as a result of side effects of the malfunction of other system components.

The increased introduction of Ethernet technology for communication in process control technology between plant parts and control functions reduced this technical barrier, thus jeopardizing, for example, the confidentiality and integrity of the transmitted and processed data and the availability of the services used therefor on the communication subscribers. It is also known from the publication http://de.wikipedia.org/wiki/Ethernet that a security risk springs from the principle-related broadcast messages in which any information transmitted by one subscriber is received by every other subscriber.

As a result of being connected to Ethernet, these components are thus potentially jeopardized to a considerably greater extent. In order to counteract this, communication to and from the device can be signed or, if appropriate, completely encrypted. The communication subscribers should be enabled to be authenticated as legitimate network subscribers and to additionally protect their communication contents from access by other, non-authenticated subscribers. Depending on the security specifications and other operating specifications, this can involve protecting the message from modification of the contents by undesirable network subscribers or else protecting the message contents from read access by undesirable subscribers.

The practice of using cryptographic methods to protect the communication integrity is also known from the abovementioned publication http://de.wikipedia.org/wiki/Ethernet. Either jointly agreed keys (shared secrets) or asymmetrical key pairs (private/public keys) can be used for this purpose. Since a plant network includes a large number of network subscribers, management of the keys is associated with a considerable amount of manual effort or forces the introduction of automated services such as key distribution and certificate management. However, the introduction of such an infrastructure should not result in a reduction in the availability of the automation system and should not provide further attack possibilities for a potential intruder. In addition, any additional effort for the plant operator and the operating personnel should be maintained as low as possible.

### SUMMARY

A process control system is disclosed, comprising: a plurality of spatially distributed, internetworked network subscribers interconnected with secure communication, communication integrity being based on an interchange of certificates; and an integrated central certification point for allocating and distributing certificates.

### BRIEF DESCRIPTION OF THE DRAWINGS

Exemplary embodiments will subsequently be explained in more detail in conjunction with the drawing. All elements which are not required for the direct understanding of the embodiment have been omitted. In the drawing:

Then sole FIGURE illustrates an exemplary embodiment of a process control system as disclosed herein.

### DETAILED DESCRIPTION

A process control system is disclosed whose subscribers can communicate with one another using Ethernet technologies, in which case the communication integrity is protected with little effort.

An exemplary process control system is disclosed whose communication integrity can be based on an interchange of certificates.

According to exemplary embodiments, the process control system has a central certification point which is an integral part of the process control system and the task of which is to allocate and distribute the certificates. This certification point can, for example, be installed as a service on one of the computers in the system. Alternatively, the certification point can be connected to the process control system via a separate system component.

In this case, the existing functions and elements of the distributed process control system can be advantageously used to construct an infrastructure for key and certificate management. A secure infrastructure for key and certificate management for a process control system can be achieved in this case without reducing the availability of the latter and without introducing new paradigms for observing and operating the process control system. Consequently, the effort needed to implement and operate the infrastructure for key and certificate management in the process control system can remain low.

An exemplary method is also disclosed which can be introduced with a minimum amount of additional effort and costs for operating the process control system.

In an exemplary embodiment, the run-time functions of the process control system are at least temporarily dependent on the availability of the certification point. For example, it is assumed that the certification point is used to renew expiring certificates, is periodically used to distribute updated lists of certificates which have been cancelled in the meantime and should be informed of a compromised certificate. Therefore, it appears to be expedient to monitor the function of the certification point using the same methods as are also applied to other elementary functions of the process control system. In addition, relevant events with regard to certificate management, for example the updating of expired certificates or the withdrawal of compromised certificates, are logged using the methods of the process control system and, if desired, are displayed to the plant operator.

In order to issue certificates, the certification point can be involved in two cases:
a) when adding further network subscribers, the certification point is which to create a certificate for the new network subscriber; and
b) the certification point is used to renew existing certificates in the system.

In addition, depending on the type of recall information distribution selected, which may be effected either in the form of certificate revocation lists (CRL) distributed in the system or by validating the certificate during each access operation, the certification point can be used to update precisely this information at particular times by recreating and signing the certificate revocation lists (CRL). If a private key of one of the network subscribers is compromised, the certification point withdraws the compromised certificate and creates an updated CRL. The network subscriber can then be incorporated in the communication network again with a newly generated key by allocating a certificate.

Compared with other functions of the process control system, the availability demands imposed on the certification point are not particularly high, but a limited period of time for restoring its function (MTTR) should be ensured. Various methods are disclosed for achieving this.

Another feature disclosed herein provides for arranging the certification point on a system component with its own high degree of availability. For example, a component close to the process (field control station) can be selected for this purpose.

In a first exemplary embodiment, the certification point is continuously kept in operation. The certification point is thus constantly available and the period of time for restoring its function (MTTR) is virtually equal to zero. The availability of the certification point is indicated to the operating personnel and maintenance personnel of the plant using the existing alarm functions of the process control system. In this case, it may be useful to also use the certification point to validate the certificates during each access operation.

In a second exemplary embodiment, the certification point is switched off as long as its function is not required in the process control system. This measure can advantageously largely prevent the certification point being reached, as a target, by external attacks.

According to another exemplary feature disclosed herein, the start-up of the certification point is initiated by a central system function which determines the remaining residual term of the certificates of the network subscribers and causes the certification point to be activated in the event of imminent expiry of the term.

According to an alternative exemplary feature disclosed herein, the start-up of the certification point is initiated in a decentralized manner by the individual network subscribers which monitor the validity of their certificate information themselves.

In both cases, a system alarm is generated if the certification point is not available in the communication network.

According to another exemplary feature disclosed herein, the process control system comprises a maintenance management system. Such a maintenance management system can be used to manage the maintenance state of the complex components connected to the process control system, for example field devices. In order to increase the availability, provision may be made for a job order containing the measures to be carried out by the maintenance personnel in order to restore the function of the certification point to be transmitted to the connected maintenance management system. For example, provision may be made for the measures to be initiated to be directly added to the process alarm. Alternatively, provision may be made for an action to be directly initiated in the maintenance management system (CMMS) connected to the process control system.

This advantageously makes it possible to initiate correction measures with little effort if the certification point is not available.

Another exemplary feature disclosed herein provides for the key management functions to be monitored and logged using the process control system. The existing reporting and log system of the process control system is used for this purpose by virtue of the events being recorded and stored in the form of system messages. In such a form, they are then available, together with other messages, for subsequent archiving, interrogation and analysis.

The renewal of certificates can be advantageously logged for subsequent diagnoses and analyses without a noticeable impairment in the operation of the process control system.

Another exemplary feature disclosed herein provides for the successful recall of certificates to be monitored using the functions of the process control system.

The recall of a certificate, that is to say the active cancellation of a relationship of trust before the expiry of the agreed time, has proven to be difficult to implement, for example in an open and changing environment such as the Internet. Within a process control system, provision is made for the monitoring and reporting functions to be used to monitor the recall process and to ensure that the information has been processed by all network subscribers. For this purpose, provision is made, for example, to warn the plant operator if individual components could not be reached for the recall and are therefore potentially operating with data of a non-secure origin.

Another exemplary feature disclosed herein provides for a process control system to actively look for and report non-authenticated access attempts or to even actively exclude network subscribers, from which such communication starts or which do not have the latest certificate revocation lists containing a summary of the invalid certificates, from participating in the network.

Exemplary embodiments will be explained in more detail. The single figure illustrates only the components of a process control system which are essential for one skilled in the art to understand the embodiment. The process control system includes a plurality of spatially distributed, internetworked network subscribers (e.g., subscriber stations) 1, 2, 3 and 4 which are connected to one another via a communication network 6. The integrity of the communication between the network subscribers 1, 2, 3 and 4 is safeguarded by interchanging certificates 7.

The network subscribers 1, 2, 3 and 4 have different tasks within the process control system. The network subscriber 2 is thus selected, as the central certification point 5 in the process control system, to allocate and distribute the certificates 7. The certification point 5 is installed, as an integral part of the process control system, as a service on a network subscriber 2 of the process control system. This can, for example, advantageously make it possible to dispense with additional network subscribers in the process control system.

The network subscriber 2 can have a redundant design and thus has a very high degree of availability in the process control system. The certification point 5 is arranged on the highly available network subscriber 2 and can thus be advantageously likewise highly available with any specified degree of availability.

In an alternative exemplary embodiment, the certification point 5 may also be arranged on a component close to the process. In addition, the certification point 5 may also be arranged such that it is connected to the process control system via a separate system component.

Irrespective of the location of the certification point 5 in the process control system, provision may be made to continuously keep the certification point in operation. The certificates 7 can thus be advantageously allocated and distributed at any time in the entire process control system.

An alternative exemplary embodiment can provide for the certification point 5 to be activated, if desired, on the basis of the remaining residual term of the certificates 7 of the network subscribers 1, 2, 3 and 4 and for the start-up to be initiated by a central system function.

For example, provision may be made for the certification point 5 to be activated, if desired, on the basis of the remaining residual term of the certificates 7 of the network subscribers 1, 2, 3 and 4 and for the start-up to be initiated in a decentralized manner by the individual network subscribers 1, 2, 3 and 4. The availability of the certification point 5 can advantageously be indicated to the operating personnel and maintenance personnel of the plant using the existing alarm functions of the process control system.

Another exemplary embodiment of the process control system provides for a system alarm to be generated if the certification point 5 is not available in the communication network 6.

In another exemplary refinement, a maintenance management system is provided for the purpose of managing the complex components connected to the process control system and is designed to initiate measures for managing the certificates. This can, for example, be effected by starting a service, either by means of manual intervention by the operator or automatically by the system.

For example, provision may be made for the measure to be initiated to be added to a process alarm. In this case, the methods already implemented in the process control system can be advantageously used to manage the certificates, thus making it possible to dispense with implementing new special methods.

Alternatively, provision may be made for the measure to be initiated to be directly initiated in the maintenance management system, for example if a service is not available, manual interventions such as the switching-on of components or the starting of software services.

In another form, the existing reporting and log system of the process control system can be designed to monitor and log the key management functions using the process control system by virtue of the events being recorded and stored in the form of system messages.

For example, the functions of the process control system are designed to monitor the successful recall of certificates 7.

In addition, the functions of the process control system can be designed to actively look for and report non-authenticated access attempts. For this purpose, in a similar manner to the failure of a system component, a system alarm can be generated and can be both indicated to the plant operator and recorded in logs.

In another exemplary refinement, it is also possible for the system to change to predefined secure system states in the event of presumed intrusion attempts in order to avoid further damage to the automated plant.

In another exemplary refinement, the functions of the process control system can bee designed to determine network subscribers 1, 3 or 4 which access the communication network 6 without authentication.

In addition, the functions of the process control system are designed to exclude network subscribers 1, 3 or 4 from communication which do not have the latest certificate revocation lists.

In another exemplary refinement, the functions of the process control system can be designed to change the plant, which is automated by the system, to a predefined state in the event of non-authenticated access attempts. The plant is changed to a secure state in this case. This may be effected by switching off plant parts, for example. In addition, parts of the plant may also be isolated from the rest.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1, 2, 3, 4 Network subscribers

5 Certification point

6 Communication network

7 Certificate

1. A process control system, comprising:
a plurality of spatially distributed, internetworked network subscribers interconnected with secure communication, communication integrity being based on an interchange of certificates; and
an integrated central certification point for allocating and distributing certificates.

2. The process control system as claimed in claim 1,wherein the certification point is installed as a service on a network subscriber of the process control system.

3. The process control system as claimed in claim 1,wherein the certification point is connected to the process control system via a separate system component.

4. The process control system as claimed in claim 1,wherein the certification point is arranged on a system component having a specified degree of availability.

5. The process control system as claimed in claim 1,wherein the certification point is arranged on a component close to a process to be controlled.

6. The process control system as claimed in claim 1,wherein the certification point is configured to be continuously in operation.

7. The process control system as claimed in claim 1, wherein the certification point operates on a basis of remaining residual term of the certificates of the network subscribers, and a central system function is configured to initiate start-up.

8. The process control system as claimed in claim 1, wherein the certification point operates on a basis of remaining residual term of the certificates of the network subscribers, and individual network subscribers are configured to initiate start-up in a decentralized manner.

9. The process control system as claimed in claim 1, wherein availability of the certification point can be indicated to the operating personnel and maintenance personnel of a plant using existing alarm functions of the process control system.

10. The process control system as claimed in claim 1, configured to generate a system alarm when the certification point is not available in the communication network.

11. The process control system as claimed in claim 1, comprising:
a maintenance management system for managing complex components connected to the process control system, and for initiating a measure by maintenance personnel for managing the certificates.

12. The process control system as claimed in claim 11, wherein the measure to be initiated is added to a process alarm.

13. The process control system as claimed in claim 11, wherein the measure to be initiated can be directly initiated in the maintenance management system.

14. The process control system as claimed in claim 1, comprising:
a reporting and log system of the process control system, for monitoring and logging key management functions using the process control system by virtue of events recorded and stored as system messages.

15. The process control system as claimed in claim 14,wherein functions of the process control system are configured to monitor successful recall of certificates.

16. The process control system as claimed in claim 1,wherein functions of the process control system are configured to actively look for and report non-authenticated access attempts.

17. The process control system as claimed in claim 1,wherein functions of the process control system are configured to determine network subscribers which access the communication network without authentication.

18. The process control system as claimed in claim 17, wherein functions of the process control system are configured to exclude network subscribers from communication which access the communication network without authentication.

19. The process control system as claimed in claim 17, wherein functions of the process control system are configured to exclude network subscribers from communication which do not have a latest certificate revocation list.

20. The process control system as claimed in claim 17, wherein functions of the process control system are configured to change a plant, which is automated by the system, to a predefined state in an event of non-authenticated access attempts.
